(19) United States
(12) Patent Application Publication
(10) Pub. No.: US 2025/0386401 A1
(43) Pub. Date: Dec. 18, 2025

(54) Thermally-insulating material and heating blanket

(71) Applicant: Shenzhen Street Cat Technology Co., Ltd., Shenzhen (CN)

(72) Inventor: Zeda HU, Shenzhen (CN)

(73) Assignee: Shenzhen Street Cat Technology Co., Ltd., Shenzhen (CN)

(21) Appl. No.: 18/788,041

(22) Filed: Jul. 29, 2024

(30) Foreign Application Priority Data
Jun. 14, 2024 (CN) 202421359850.6

(51) Int. Cl. H05B 3/34; B32B 5/02; B32B 5/26; B32B 7/027; H05B 3/36

(52) U.S. Cl. CPC H05B 3/342; B32B 5/02; B32B 5/26; B32B 7/027; H05B 3/36; B32B 2262/0276; B32B 2262/062; B32B 2262/16; B32B 2307/302; B32B 2307/304; B32B 2457/00

(57) ABSTRACT

A thermally-insulating material includes a heating element, a thermally-insulating fabric layer arranged at one side of the heating element, and a thermally conductive layer arranged at the other side of the heating element. The heating element can be connected to a power supply to generate heat, thereby allowing the self-heating of the thermally-insulating material. A thermal conductivity of the thermally-insulating fabric layer is lower than a thermal conductivity of the thermally conductive layer, and the thermally conductive layer is adjacent to a to-be-insulated object. In the thermally-insulating material, an inner fabric layer is distinguished from an outer fabric layer. The inner fabric layer can attach to the to-be-insulated object, and is a thermally conductive layer with a high thermal conductivity. The inner fabric layer is configured to quickly conduct heat generated by the heating element to the to-be-insulated object, thereby improving a heat conduction efficiency.

### CROSS REFERENCE TO THE RELATED APPLICATIONS

This application is based upon and claims priority to Chinese Patent Application No. 202421359850.6, filed on Jun. 14, 2024, the entire contents of which are incorporated herein by reference.

### TECHNICAL FIELD

The present disclosure relates to the technical field of thermally-insulating materials, and in particular to a thermally-insulating material and a heating blanket.

### BACKGROUND

A main function of a thermally-insulating material is to prevent heat loss, while the heat loss is mainly caused by conduction, convection, and radiation.

The existing heating and thermally-insulating materials and heating blankets all adopt a simple three-layer structure, which is a symmetrical structure without distinguishing an inner layer and an outer layer. In the three-layer structure, a heating element is in the middle, and the other two layers are arranged at two sides of the heating element, respectively. The two layers arranged at two sides of the heating element have exactly the same structure and both are attached to a to-be-insulated object. When heat generated by the heating element is conducted to a to-be-insulated object through a structure at one side, the heat also loses through exactly the same structure at the other side, such that the heat dissipates quickly. This causes an insufficient temperature of the to-be-insulated object, a large energy consumption, and a failed thermal insulation effect.

### SUMMARY

### (I) Technical Problem to be Solved

In view of the above-mentioned shortcomings and deficiencies of the prior art, the present disclosure provides a thermally-insulating material and a heating blanket, which solves the technical problem that a heating element undergoes rapid heat dissipation due to a poor thermal insulation effect of a thermally-insulating material.

### (II) Technical Solutions

In order to allow the above objective, the present disclosure provides a thermally-insulating material, including a heating element, a thermally-insulating fabric layer arranged at one side of the heating element, and a thermally conductive layer arranged at the other side of the heating element, where the heating element is configured to be connected to a power supply to generate heat;
a thermal conductivity of the thermally-insulating fabric layer is lower than a thermal conductivity of the thermally conductive layer; and the thermally conductive layer is adjacent to a to-be-insulated object.

Optionally, the thermally-insulating fabric layer includes a plurality of fabric layers attached to each other.

Optionally, the thermally-insulating fabric layer includes a fabric layer, a reflective layer, and at least one thermally-insulating layer that are attached to each other sequentially, and the thermally-insulating layer is adjacent to the heating element.

Optionally, the fabric layer includes a skin-friendly fabric and a thermal insulation material, and the thermal insulation material is arranged between the skin-friendly fabric and the reflective layer.

Optionally, the skin-friendly fabric includes one or more of a spandex plush, a flannel, a plush, and a microplush.

Optionally, the thermal insulation material includes one or more of polyester padding, washable cotton, silk-like cotton, natural cotton, and wool.

Optionally, the reflective layer includes one or more of a graphene thermally-insulating fabric, an aluminum film, a silver-plated paper, a glass fiber aluminum foil, a polyvinyl chloride aluminum film, and a pearl cotton aluminum film.

Optionally, the thermally-insulating layer includes a plurality of layers of a hollow fiber structure, and a plurality of air gaps are formed in each layer of the hollow fiber structure.

Optionally, a flame-retardant layer is provided between the heating element and the thermally-insulating layer.

Optionally, the thermally conductive layer includes a polyester fiber layer and a flame-retardant cotton layer, and the flame-retardant cotton layer is arranged between the polyester fiber layer and the heating element.

Further, the present disclosure also provides a heating blanket, including a controller, a power interface, and the thermally-insulating material described above, where the power interface is arranged on the thermally-insulating fabric layer, the power interface is in wire connection with the heating element, and the power interface is in wire connection with a power supply through the controller.

Optionally, the controller at least includes one or more of a control switch, a temperature control circuit, a time control circuit, a temperature monitoring circuit, an overload protection circuit, and a short-circuit protection circuit.

### (III) Beneficial Effects

The heating element can be connected to a power supply to generate heat, thereby allowing the self-heating of the thermally-insulating material. The heating element is configured to allow continuous heating for a to-be-insulated object. A thermal conductivity of the thermally-insulating fabric layer is lower than a thermal conductivity of the thermally conductive layer, and the thermally conductive layer is adjacent to a to-be-insulated object. In the thermally-insulating material, an inner fabric layer is distinguished from an outer fabric layer. The inner fabric layer can attach to a to-be-insulated object, and is a thermally conductive layer with a high thermal conductivity. The inner fabric layer is configured to quickly conduct heat generated by the heating element to a to-be-insulated object, thereby improving a heat conduction efficiency. The outer fabric layer is made of a fabric with a low thermal conductivity. The outer fabric layer is configured to isolate the heating element from an external environment and reduce a heat exchange between the external environment and the heating element and between the external environment and a to-be-insulated object, thereby reducing the heat dissipation and reducing the energy consumption of the heating element while increasing a temperature of the to-be-insulated object.

### BRIEF DESCRIPTION OF THE DRAWINGS

FIG. 1 is a schematic structural diagram of the thermally-insulating material of the present disclosure; and

FIG. 2 is a schematic diagram of a material distribution in the thermally-insulating material of the present disclosure.

### REFERENCE NUMERALS

1: fabric layer; 11: skin-friendly fabric; 12: thermal insulation material;
2: reflective layer;
3: thermally-insulating layer; 31: hollow fiber structure;
4: heating element;
5: thermally conductive layer; 51: flame-retardant cotton layer; 52: polyester fiber layer; and
6: flame-retardant layer.

### DETAILED DESCRIPTION OF THE EMBODIMENTS

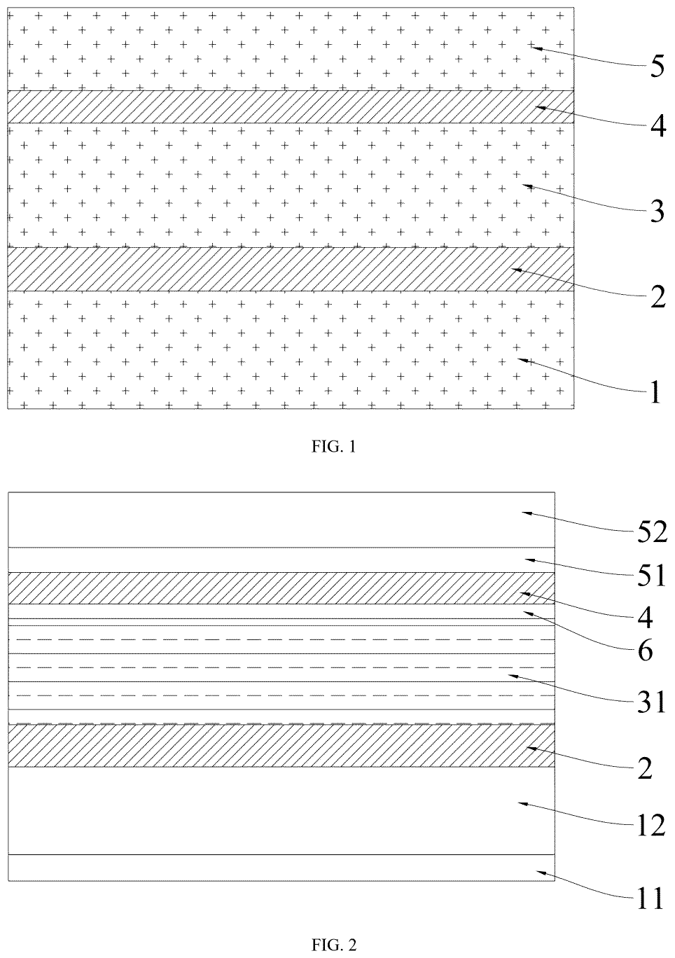

In order to well explain the present disclosure and facilitate the comprehension, the present disclosure is described in detail below with reference to the accompanying drawings and specific implementations. The terms such as “upper” and “lower” mentioned herein are based on the orientations shown in FIG. 1.

Although the accompanying drawings show the exemplary embodiments of the present disclosure, it should be understood that the present disclosure may be implemented in various forms and should not be limited to the embodiments set forth herein. On the contrary, these embodiments are provided such that the present disclosure can be understood clearly and thoroughly and the scope of the present disclosure can be fully conveyed to those skilled in the art.

As shown in FIG. 1, the present disclosure provides a thermally-insulating material, including heating element 4, a thermally-insulating fabric layer arranged at one side of the heating element 4, and thermally conductive layer 5 arranged at the other side of the heating element 4. The heating element 4 can be connected to a power supply through a power controller to generate heat, thereby allowing the self-heating of the thermally-insulating material. The heating element is configured to allow continuous heating for a to-be-insulated object. In a specific embodiment, the heating element 4 includes a heating wire, a heating film, a heating sheet, a heating cloth, or the like. A thermal conductivity of the thermally-insulating fabric layer is lower than a thermal conductivity of the thermally conductive layer 5, and the thermally conductive layer 5 is adjacent to a to-be-insulated object. In the thermally-insulating material, an inner fabric layer is distinguished from an outer fabric layer. The inner fabric layer can attach to a to-be-insulated object, and is the thermally conductive layer 5 with a high thermal conductivity. The inner fabric layer is configured to quickly conduct heat generated by the heating element 4 to a to-be-insulated object, thereby improving a heat conduction efficiency. The outer fabric layer is made of a fabric with a low thermal conductivity. The outer fabric layer is configured to isolate the heating element 4 from an external environment and reduce a heat exchange between the external environment and the heating element 4 and between the external environment and a to-be-insulated object, thereby reducing the heat dissipation and reducing the energy consumption of the heating element 4 while increasing a temperature of the to-be-insulated object.

It should be noted that a conventional power controller is adopted for controlling a temperature and power supply time of the heating unit, and thus when the thermally-insulating material acts on the human body, it can avoid low-temperature scalding caused by long-term heating.

Further, the thermally-insulating fabric layer includes a plurality of fabric layers attached to each other, which can further reduce the dissipation of heat and effectively play a thermal insulation role.

In an embodiment, the thermally-insulating fabric layer includes fabric layer 1, reflective layer 2, and at least one thermally-insulating layer 3 that are attached to each other sequentially. A plurality of the thermally-insulating layers 3 attach to each other to form a whole, which can allow an effective thermal insulation effect and reduce the dissipation of heat. The reflective layer 2 may have a single-sided reflection structure in which a reflective surface faces towards the thermally-insulating layer 3 and is configured to reflect heat generated by the heating element 4. Or, the reflective layer 2 may have a single-sided reflection structure in which a reflective surface faces towards the fabric layer 1 and is configured to reflect cold energy of an external environment. Or, the reflective layer 2 can have a double-sided reflection structure, which can reflect both heat generated by the heating element 4 and cold energy of an external environment, thereby playing a role of isolating the external environment. When the reflective layer with the double-sided reflection structure is arranged, there is no need to distinguish between front and back sides of the reflective layer 2, which can effectively reduce the arrangement requirements of the reflective layer 2. The fabric layer 1 can reduce a heat exchange between an external environment and a to-be-insulated object, thereby retaining the internal heat and preventing the dissipation of heat. The reflective layer 2 can effectively reduce the radiative heat dissipation through reflection to further lock the heat generated by the heating element 4, thereby further preventing the dissipation of heat. The thermally-insulating layer 3 is in direct contact with the heating element 4, which can effectively increase a still air content between the heating element 4 and the reflective layer 2 and reduce the heat conduction, thereby playing a thermal insulation role to a maximum extent.

Further, the fabric layer 1 includes skin-friendly fabric 11 and thermal insulation material 12, and the thermal insulation material 12 is arranged between the skin-friendly fabric 11 and the reflective layer 2. The skin-friendly fabric 11 feels comfortably, which can improve a comfort level experienced by a user. The thermal insulation material 12, as a first thermal insulation layer adjacent to an external environment, is configured to reduce a heat exchange between the external environment and a to-be-insulated object, thereby first locking heat. The skin-friendly fabric 11 includes one or a combination of two or more of a spandex plush, a flannel, a plush, and a microplush. The thermal insulation material 12 includes one or a combination of two or more of polyester padding, washable cotton, silk-like cotton, natural cotton, and wool.

The reflective layer 2 is made of a material that can reflect heat and gather heat. The reflective layer can reduce the radiative heat dissipation through reflection to further lock the heat generated by the heating element 4, thereby further preventing the dissipation of heat. The reflective layer 2 includes one or a combination of two or more of a graphene thermally-insulating fabric, an aluminum film, a silver-plated paper, a glass fiber aluminum foil, a polyvinyl chloride aluminum film, and a pearl cotton aluminum film.

The thermally-insulating layer 3, as a second thermal insulation layer, includes a plurality of layers of hollow fiber structure 31, and a plurality of air gaps are formed in each layer of the hollow fiber structure 31. Specifically, the hollow fiber structure 31 consists of extremely-thin fibers with a much smaller diameter than the conventional polyester fibers, and these microfibers can form a tight network to capture air. Thermally-insulating cotton consists of a plurality of layers of fibers, and there are tiny air gaps between layers. The overall structure is also porous, which can further improve the ability to capture air. The fiber structure itself has specified hydrophobicity, which can prevent the absorption of moisture, keep dry, and improve the thermal insulation performance. The hollow fiber and the porous structure work together to capture a large amount of still air to form an insulating layer. The still air is a very effective insulator that can greatly reduce the loss of heat. In addition, the hollow fiber structure 31 can also effectively capture and reflect the infrared radiation heat emitted by a to-be-insulated object and the heating element 4, and such an efficient heat-capture ability can provide an excellent thermal insulation effect. The hydrophobicity of the hollow fiber structure 31 makes it possible to keep dry even in a humid environment, thereby maintaining the thermal insulation performance. The thermally-insulating layer 3 includes one or a combination of two or more of Lithermo wadding, 3M thinsulate insulation wadding, a down material, graphene wadding, herbal antimicrobial wadding, and Dupont sorona wadding.

Flame-retardant layer 6 is provided between the heating element 4 and the thermally-insulating layer 3. The flame-retardant layer 6 is preferably made of a flexible thin material, and is configured to prevent the heating element 4 from igniting the thermally-insulating layer 3 due to a short circuit, thereby improving the safety performance of the thermally-insulating material.

The thermally conductive layer 5 is made of a velvet/cotton composite with high thermal conductivity, and includes polyester fiber layer 52 and flame-retardant cotton layer 51. The flame-retardant cotton layer 51 is arranged between the polyester fiber layer 52 and the heating element 4. The thermally conductive layer 5 is adjacent to a to-be-insulated object, and can allow the fast inward transmission of increased heat. The arrangement of the flame-retardant cotton layer 51 with flame-retardant performance as a middle layer between the heating element 4 and the polyester fiber layer 52 can prevent the heating element 4 from igniting the polyester fiber layer 52 due to a short circuit, thereby further improving the safety performance.

Further, the present disclosure also provides a heating blanket, including a controller, a power interface, and a thermally-insulating material described above. Because the thermally-insulating fabric layer faces outwards, the power interface is preferably arranged on the thermally-insulating fabric layer to facilitate the connection of a power supply line, and the power interface is prevented from a side contacting a to-be-insulated object, thereby avoiding the electric leakage and effectively improving the comfort level and safety performance for users. An output end of the power interface is in wire connection with the internal heating element. An input end of the power interface, the controller, and a power supply are connected sequentially through wires. The power interface is connected to the controller through a quick-release interface, resulting in a convenient operation.

Further, the controller at least includes one or more of a control switch, a temperature control circuit, a time control circuit, a temperature monitoring circuit, an overload protection circuit, and a short-circuit protection circuit. The temperature control is conducted to set a heating temperature of the heating element, which is allowed through the coordination of a program stored in the controller with the temperature control circuit. The working time adjustment is conducted as follows: based on a principle of a timer, the automatic power off is allowed after a set time is reached, which can avoid low-temperature scalding caused by continuous heating when acting on the human body. The temperature monitoring, overload protection, and short-circuit protection are allowed by the conventional protection circuits.

It should be understood that in the description of the present disclosure, terms such as “first” and “second” are used merely for the purpose of description, and should not be construed as indicating or implying relative importance, or implicitly indicating the number of technical features denoted. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified and defined, the terms “arrangement”, “interconnection”, “connection”, and “fixation” are intended to be understood in a broad sense. For example, the connection may be a fixed connection, removable connection, or integral connection, may be a mechanical connection or electrical connection, may be a direct connection or an indirect connection through an intermediate medium, and may be an intercommunication or an interaction between two components. Those of ordinary skill in the art may understand the specific meanings of the above terms in the present disclosure based on specific situations.

In the present disclosure, unless otherwise explicitly specified and defined, “a first feature is above or below a second feature” may indicate that “the first and second features are in direct contact” or “the first and second features are in indirect contact through an intermediate medium”. In addition, when it is described that the first feature is “over”, “above”, and “on” the second feature, it indicates that the first feature is directly or obliquely above the second feature, or simply indicates that the first feature is higher than the second feature. When it is described that a first feature is “under”, “below”, or “beneath” a second feature, it indicates that the first feature is directly or obliquely under the second feature or simply indicates that the first feature is lower than the second feature.

In the description of this specification, the description with reference to the terms such as “one embodiment”, “some embodiments”, “embodiments”, “an example”, “a specific example”, and “some examples” indicate that the specific features, structures, materials, or characteristics described with reference to the embodiment or example are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without mutual contradiction.

Although the embodiments of the present disclosure have been illustrated and described above, it should be understood that the above embodiments are exemplary, and may not be construed as limitations to the present disclosure. A person of ordinary skill in the art may make various changes, modifications, replacements, and variations to the above embodiments within the scope of the present disclosure.

1. A thermally-insulating material, comprising a heating element, a thermally-insulating fabric layer arranged at a first side of the heating element, and a thermally conductive layer arranged at a second side of the heating element, wherein the heating element is configured to be connected to a power supply to generate heat; and
a thermal conductivity of the thermally-insulating fabric layer is lower than a thermal conductivity of the thermally conductive layer; and the thermally conductive layer is adjacent to a to-be-insulated object.

2. The thermally-insulating material according to claim 1, wherein the thermally-insulating fabric layer comprises a plurality of fabric layers attached to each other.

3. The thermally-insulating material according to claim 2, wherein the thermally-insulating fabric layer comprises a fabric layer, a reflective layer, and a thermally-insulating layer, wherein the fabric layer, the reflective layer and the thermally-insulating layer are attached to each other sequentially, and the thermally-insulating layer is adjacent to the heating element.

4. The thermally-insulating material according to claim 3, wherein the fabric layer comprises a skin-friendly fabric and a thermal insulation material, and the thermal insulation material is arranged between the skin-friendly fabric and the reflective layer.

5. The thermally-insulating material according to claim 4, wherein the skin-friendly fabric comprises one or more of a spandex plush, a flannel, a plush, and a microplush.

6. The thermally-insulating material according to claim 4, wherein the thermal insulation material comprises one or more of polyester padding, washable cotton, silk-like cotton, natural cotton, and wool.

7. The thermally-insulating material according to claim 3, wherein the reflective layer comprises one or more of a graphene thermally-insulating fabric, an aluminum film, a silver-plated paper, a glass fiber aluminum foil, a polyvinyl chloride aluminum film, and a pearl cotton aluminum film.

8. The thermally-insulating material according to claim 3, wherein the thermally-insulating layer comprises a plurality of layers of a hollow fiber structure, and a plurality of air gaps are formed in each layer of the hollow fiber structure.

9. The thermally-insulating material according to claim 3, wherein a flame-retardant layer is provided between the heating element and the thermally-insulating layer.

10. The thermally-insulating material according to claim 3, wherein the thermally conductive layer comprises a polyester fiber layer and a flame-retardant cotton layer, and the flame-retardant cotton layer is arranged between the polyester fiber layer and the heating element.

11. A heating blanket, comprising a controller, a power interface, and the thermally-insulating material according to claim 1, wherein the power interface is arranged on the thermally-insulating fabric layer, the power interface is in wire connection with the heating element, and the power interface is in wire connection with the power supply through the controller.

12. The heating blanket according to claim 11, wherein the controller comprises one or more of a control switch, a temperature control circuit, a time control circuit, a temperature monitoring circuit, an overload protection circuit, and a short-circuit protection circuit.

13. The heating blanket according to claim 11, wherein in the thermally-insulating material, the thermally-insulating fabric layer comprises a plurality of fabric layers attached to each other.

14. The heating blanket according to claim 13, wherein in the thermally-insulating material, the thermally-insulating fabric layer comprises a fabric layer, a reflective layer, and a thermally-insulating layer, wherein the fabric layer, the reflective layer and the thermally-insulating layer are attached to each other sequentially, and the thermally-insulating layer is adjacent to the heating element.

15. The heating blanket according to claim 14, wherein in the thermally-insulating material, the fabric layer comprises a skin-friendly fabric and a thermal insulation material, and the thermal insulation material is arranged between the skin-friendly fabric and the reflective layer.

16. The heating blanket according to claim 15, wherein in the thermally-insulating material, the skin-friendly fabric comprises one or more of a spandex plush, a flannel, a plush, and a microplush.

17. The heating blanket according to claim 15, wherein in the thermally-insulating material, the thermal insulation material comprises one or more of polyester padding, washable cotton, silk-like cotton, natural cotton, and wool.

18. The heating blanket according to claim 14, wherein in the thermally-insulating material, the reflective layer comprises one or more of a graphene thermally-insulating fabric, an aluminum film, a silver-plated paper, a glass fiber aluminum foil, a polyvinyl chloride aluminum film, and a pearl cotton aluminum film.

19. The heating blanket according to claim 14, wherein in the thermally-insulating material, the thermally-insulating layer comprises a plurality of layers of a hollow fiber structure, and a plurality of air gaps are formed in each layer of the hollow fiber structure.

20. The heating blanket according to claim 14, wherein in the thermally-insulating material, a flame-retardant layer is provided between the heating element and the thermally-insulating layer.
